(19) United States
(12) Patent Application Publication
(10) Pub. No.: US 2014/0192425 A1
(43) Pub. Date: Jul. 10, 2014

(54) Vision Launch

(71) Applicant: Edwin F. Pryor, Coconut Creek, FL (US)

(72) Inventor: Edwin F. Pryor, Coconut Creek, FL (US)

(21) Appl. No.: 13/404,939

(22) Filed: Jan. 7, 2013

(51) Int. Cl. G02B 25/00

(52) U.S. Cl. CPC G02B 25/002
USPC 359/721

(57) ABSTRACT

Vision Launch has created a product, patent pending that is a thin film (approximately 0.13 mm) that is adhered/slightly sticky on borders, across an electronic screen and it is magnified via various diopter strengths. A human with farsightedness can now read the small print/screen without the assistance of reading glasses.

The product developed by Vision Launch can be placed on a Cellular phone, I-pad, Kindle, Computer screen or any and all electronic devices with a screen. When the product is purchased it will be pre-cut to size or the consumer can cut to size, depending on the electronic product.

I have invented a new product to correct farsightedness while using a cellphone, Ipad, laptop, any electronic device with a screen, etc.

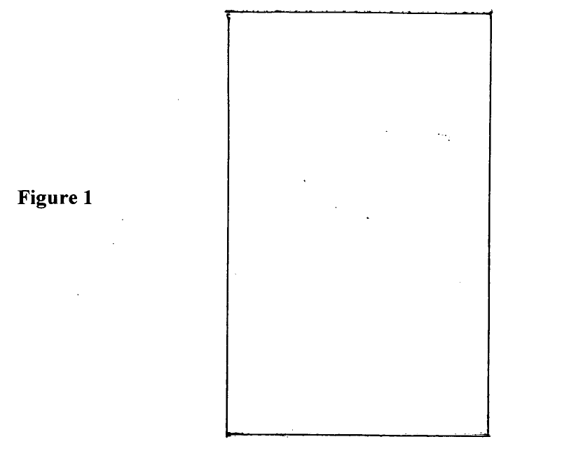

FIG. 1—is a front elevational view of the product

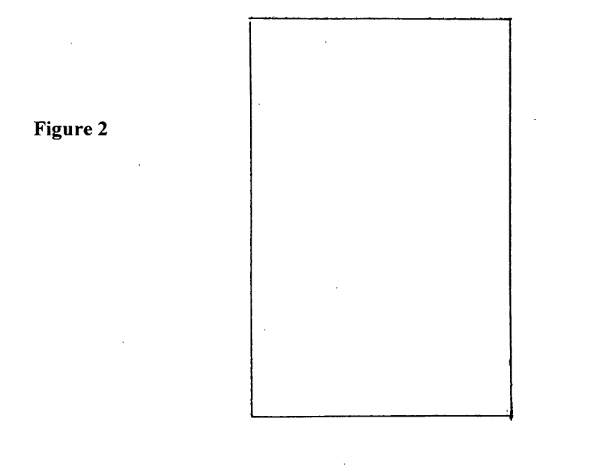

FIG. 2—is a rear elevational view thereof

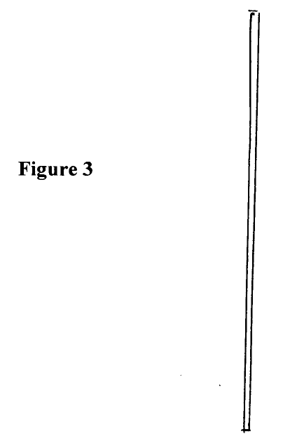

FIG. 3—is a left side elevational view thereof

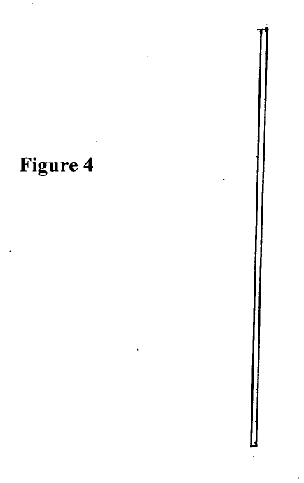

FIG. 4—is a right side elevational view thereof

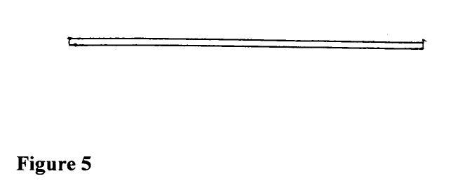

FIG. 5—is a top view thereof

the design/product has diopter strengths embedded to correct Farsightedness when looking at an electronic screen.

I claim:

1. The patented product will give farsighted humans the ability to read small print on electronic devices such as cell phones, ipads, laptops, etc.
There is no product of its type available in today's market. This is the only product available to consumers that adheres directly to the electronic screen (flush fit) to correct farsightedness. Consumers today must use reading glasses.
